(19) United States
(12) Patent Application Publication
(10) Pub. No.: US 2004/0122659 A1
(43) Pub. Date: Jun. 24, 2004

(54) Tool and method for managing web pages in different languages

(76) Inventors: John Philip Hourihane, Dublin (IE); Alan O'Kelly, Dublin (IE); Peter Walter Nolan, Dublin (IE)

Correspondence Address: Brown Rudnick Berlack Israels LLP, One Financial Center, Boston, MA, 02111, US

(21) Appl. No.: 10/329,086

(22) Filed: Dec. 23, 2002

(51) Int. Cl. G06F 17/20

(52) U.S. Cl. 704/9

(57) ABSTRACT

The approach of displaying language-specific information in a web-browser is described. The combination of the internationalized GUI and locale-specific elements (i.e. resource bundle) is performed once before deployment of the application, and the results are cached. The approach comprises extracting contents files, creating a mapping file and then applying the new mapping file to the already processed files to create a set of web pages which are language-specific.

### FIELD OF THE INVENTION

The present invention related to the field of Java-based content development. More specifically, the invention relates to the generation of the locale-specific web pages.

### BACKGROUND OF THE INVENTION

To be able to deliver a particular web page to a user in the desired language in a particular geographic area, the problem of tailoring the web page to the desired language should be resolved.

### SUMMARY OF THE INVENTION

The problem of dynamically creating and managing language specific interfaces is widely addressed by employing an approach involving resource bundles, Java's own proposed solution for localization of text. A ResourceBundle is a collection of locale-specific resources (like strings, images, etc.). When an application needs to display the label on a button, for example, it retrieves the text of the label from a ResourceBundle that is developed for the appropriate language. This lookup is performed at the time the screen is displayed to the client. In order to show the application in a different language, a different ResourceBundle is used. For example, a ResourceBundle for English might return the string “Cancel” when asked for the “cancel_button_label”, while a German version of the ResourceBundle might return “Abbrechen” when asked for the same thing.

To work in this way, it becomes necessary to extract the language-specific elements of the GUI, and encapsulate them in a mapping (a ResourceBundle or a property file). The application is then described as “internationalized”—it is now independent of any particular locale because all of the locale-specific elements have been isolate in a single place which can be easily changed.

For each target language, there would need to be a separate ResourceBundle. Under Java's normal approach, the ResourceBundle and the internationalized GUI are combined at run time to produce a localized GUI.

It should be noted that Java's ResourceBundle approach is suitable for use in an application, where the GUI is presented to the user directly on screen, rather than as a series of HTML pages in a Web browser. This is appropriate for a client-side application in which caching the locale-specific GUI is impractical and expensive.

The main difference in the approach of the present invention is that the combination of the internationalized GUI and the locale-specific elements (i.e. resource bundle) is done once, before deployment of an application, and the results are cached. The approach of the present invention removes a considerable processing burden from the server, which would otherwise need to be shouldered for each request for a page that was made. Additionally, the approach allows us to manually fine-tune the cached pages, which would not be an option in the usual approach.

According to the invention, a method of translating a web page comprises scanning an original page to select locale-specific content in the original page; enclosing the locale-specific content in predefined tags to create tagged text; extracting the tagged text from the original page to create a file mapping a set of identifiers and the locale-specific content; and translating the web page by replacing the tagged text in the original page by the content to be displayed in a translated web page.

### BRIEF DESCRIPTION OF THE DRAWINGS

FIG. 1 is a UML class diagram of the present invention.

### DETAILED DESCRIPTION OF THE INVENTION

The present invention comprises a tool and a method for providing language specific rendition of web pages requested by a user in a certain geographic location. The tool helps out with two of the steps in this process—extracting contents for localization from files and creating a mapping file (the extraction or internationalization step), and then applying a new mapping to these processed files to create a set of web pages specific to a different locale (the translation/localization step).

It should be noted that for the purposes of the present invention the difference between an HTML and JSP is not significant, so the term “web page” used in the present description refer to either one.

The starting point for the application of this invention is a suite of language specific web pages that together make up the front end of a web application. These pages may be contained in HTML pages, JSP pages, Javascript files or combinations of all of these. For purposes of illustration, we will assume that the pages are initially specific to the English language, specifically as written for a North American audience. It should be noted that the invention does not rely on this premise; the starting point can comprise pages written in any language.

The first step in the process is to internationalize the pages, which is done by enclosing the locale-specific string content in HTML tags used for that purpose. For example, a fragment of a page reading as follows

<h3>Red</h3>

would be tagged as:

<h3><localize>Red</localize></h3>

Such tagging has indicated that the string “Red” needs to be subjected to localization. In the case of Javascript and JSP files, there can also be strings which are embedded in fragments of Java code, which are tagged slightly differently, using Java code comments. For example, the piece of Java code reading

String leafcolor=“green”;

will be tagged as follow

String leafColor=/*localize*/“green”/*/localize*/;

It is noted that because this is a Java String, the quotes must be inside the marker tags; otherwise the tags themselves would form a part of the sting content, which is undesirable. This step results in pages which still contain English text (and which still display correctly, since web-browsers will ignore the <localize> tag which they do not recognize). The tool of the proposed invention recognizes tags <1> and/*1*/ (also ignored by browsers) as synonyms for <localize> and /*localize*/, for brevity.

The next step comprises extracting the tagged text and creating a file containing a mapping of identifiers to the text values establishing a correlation between the English text and the placeholders for the same text in other languages. At the point of extracting the tagged text, the present invention scans files for the tags indicating the content which has to be translated. In order to identify which files are to be processed, the following command line arguments are relevant:

| | |
|---|---|
| -d dirName | name of source directory |
| -t dirName | name of target directory |
| -x ext1, ext2, . . . | comma separated list of extensions for files to process |
| -r | (optional) recurse down directories |

For example, take a simple directory structure will look as follows:

[image]

The directories en_US contains pages to be localized. The user would run the tool from the example directory, specifying the following options on the command line:

-d en_US

-t intl

-x html,jsp,js

-r

The list of extensions to process can contain one or more extensions, separated by commas, but the list should contain no spaces. This would find all files in en_US and any subdirectories which have extensions “.html”, “.jsp” or “.js”, and create a directory structure as follows

[image]

With new files in the intl directory and below, the new files would be named the same as the originals.

Inside each new file, the <localize> tags will be supplemented with an id attribute, specifying a unique id corresponding to the content enclosed in the tags. A properties file is the created, listing the mappings of these ids to the content. So the earlier examples might now appear as follows

<h3><localize id=“M_TAG_{—}995885722621”>Red</localize></h3>

and

String leafColor=/*localize id=“M_TAG_{—}995885722620”*/“green”/*/localize*/;

and a properties file is created with the mappings

M_TAG_{—}995885722621=Red

M_TAG_{—}995885722620=“green”

The name of this file is specified on the command line using the -m option. The -a option indicates this action, which is an “extract” action at the extraction step described above.

The tool of the present invention notices repeated content, so that two tags containing the same text will result in only one entry in the properties file, so that common terms, like “Okay” and “Cancel” which may be expected to occur on multiple pages, do not appear multiple times in the properties file without any benefit.

The full command line for the operation is the following:

java com.marrakech.utils.jsp.Polyglot\hat{ }

-d en_US\hat{ }

-t intl\hat{ }

-m english.map\hat{ }

-a extract\hat{ }

-x html,jsp,js\hat{ }

-r

The options can appear in any order after the class name (i.e. Polyglot). The caret character (\hat{ }) is a line continuation character in DOS, and it will not be necessary if the command was written in a single line. If the extract function is performed a second time, only the new tags (those without ids) are extracted, and the properties file is augmented with this new information, without loosing the earlier content. The mapping file is now the subject of translation/localization. For example, to create a Spanish set of pages, a mapping file containing the same ids, but mapping to the corresponding Spanish translation of the original English text is created. This step is easily outsourced to a third party vendor of such services. Suppose, for purposes of illustration, that the result of this process is a file called “spanish.map”. A translation process (which can be performed by a vendor) takes the english.map file created as described above and returns a spanish.map file containing the same ids, but mapping to the corresponding Spanish translation of the original English text. We now use the tool of this invention to create a set of pages which are specific to the Spanish language, and specifically to an audience in Spain.

The above-described tool implements the translation/localization step by setting the -a option to “localize”. The command line specifies the name of the mapping file (the “spanish.map” file), the location of the files to be processed (the “intl” folder), and the desired location of the output (in this case a folder called “es_ES”). There are two additional options, which are relevant only to the translation/localization step. These options indicate the original locale (the -o option) and the new locale (the -n option) as follows:

java com.marrakech.utils.jsp.Polyglot\hat{ }

-d intl\hat{ }

-t es_ES\hat{ }

-m spanish.map\hat{ }

-a localize\hat{ }

-x html,jsp,js\hat{ }

-r\hat{ }

-o en_US\hat{ }

-n es_ES

The program should be run from the example directory, which should contain the spanish.map file. This will create a directory structure as follows:

[image]

Suppose the spanish.map file contained the following entries:

M_TAG_{—}995885722621=Rojo

M_TAG_{—}995885722620=“verde”

The fragments used earlier to illustrate the tagging process would now appear as follows

<h3><localize id=“M_TAG_{—}995885722621”>Rojo</localize></h3>

and

String leafColor=/*localize id=“M_TAG_{—}995885722620”*/“verde”/*/localize*/;

The translation step will also attempt to replace all occurrences of the original locale with the new locale, as specified in the command line. This will only be attempted if both the -o and the -n options are specified. This changes links (to images, pages or other resources) in the original pages, which point to files in the en_US folder, to point more appropriately to the corresponding files in the es_ES folder. For example, a hyperlink in the original set of pages, specific to American-English, which read as follow.

<a href=“/en_US/about.html”></a>

would now read

<a href=“/es_ES/about.html”></a>

keeping the user within the set of pages which is appropriate to them. The need for this can be reduced by use of relative paths, but there are occasions where it is still necessary.

The tool of the present invention outputs warnings to the screen if, during a localization operation, it encounters a tag that does not have an id attribute, or if it encounters a tag whose id does not correspond to an entry in the mapping file. A general example of a command line can be illustrated by the following example:

java com.marrakech.utilsjsp.Polyglot\hat{ }

-a action\hat{ }

-d dirName\hat{ }

-x ext1,ext2\hat{ }

-t dirName\hat{ }

-m fileName\hat{ }

[-o locale\hat{ }

-n locale\hat{ }]

[-r\hat{ }]

[-v]

The options are

| | |
|---|---|
| -a | The action to perform. Must be either “extract” or “localize”. |
| -d | The directory to search for source files. |
| -x | List of extensions to process from the source directories. |
| -t | The directory to create or use for output files. |
| -m | The name of the mapping file. |
| -o | (optional) The original locale code. |
| -n | (optional) The new locale code |
| -r | Flag to indicate that the search for source files should check |
| | directories recursively. |
| -v | Run the tool with verbose output. |

The above-described method results in a separate set of pages for each of the languages, which can be edited or modified independently. Normally there will be no need to make modifications, although there can be instances when a particular field in a page needs to be modified due to some language specific limitations or requirements, such as, for example, word size or translation of idiomatic expressions and the like. It is not uncommon, for instance, for words on a German page to require more screen space than their English counterparts.

To summarize the steps involved, the starting point is a set of web pages that are locale-specific. The locale-specific content of these pages is marked with <localize> tags. The proposed tool is used to extract the localized content to a properties file, and create a set of pages which refer to the file contents. This is the internationalized set of pages. The properties file is translated, creating a new one for the target locale. The proposed tool is used to replace the text in the internationalized pages with the translated text in the properties file for the target locale. The result of the process is a new set of pages, specific to the new target locale. This process can be used in any environment that serves web pages to a client. If the environment can process JSP pages, then these too can make use of the mechanism to localize their content.

Once sets of pages for each locale are arranged in folders named according to the locale, as illustrated in the above example where the folders are en_US (for English in the U.S.A.) and es_ES (for Spanish in Spain), it is a simple matter for the server to choose a page for display to a user. The user's locale may be established by examining the “Accept-Language” header of the browser request, or may be stored as part of the user's profile in some central database. Processing a user's request may be done without regard to what language the response is to be for, until the point at which the server has decided the locale-independent page. For example, suppose that the server has decided that the user should be shown the “inventory.jsp” page. One such page exists with that name in each of the locale-specific folders. The server merely prepends the user's locale to the page required, to arrive at the page “en_US/inventory.jsp”. This is the page which should be rendered to the user.

From the developing side, a developer creates the original set of pages, and uses the proposed tool to subsequently generate localized sets of pages. A server (web-server) stores each set pages, serving these to clients on request. There is no processing performed at the server to create locale-specific content. From the client side, a client (browser) renders the pages to the user, as normal for a web browser. There is no processing performed here that is relevant to the locale-specific display. A user normally views a coherent set of pages in a single locale.

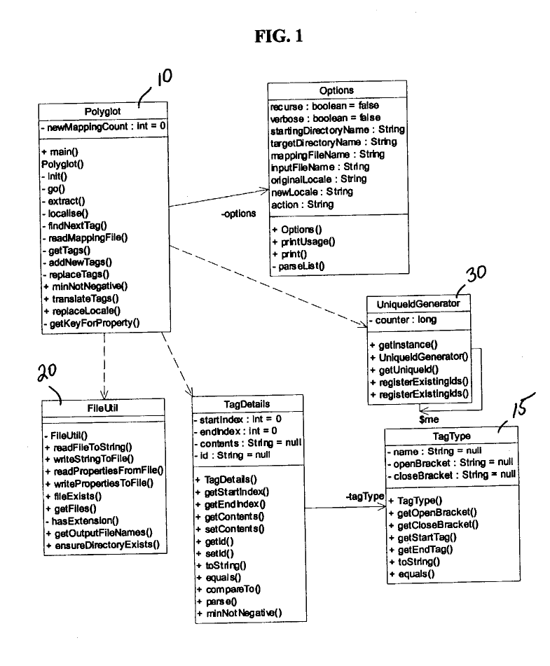

The design of the tool is now discussed with regard to a UML diagram of the relevant classes shown in FIG. 1. The entry point to the system is the ‘main’ method on the Polyglot class 10. Parsing and storing the command line options is deferred to the Options class. If the command line options are acceptable, the ‘go’ method on the Polyglot class is called. A set of TagTypes 15 is created, indicating the format of opening and closing tag-pairs that the tool scans for. At the moment, the tool scans for tags “1” and “localize”, enclosed in “< >” (for use in HTML) or “/* */” (for use in the Java code), although obviously the design allows for easy extension of this set.

For each task (extract and localize) the system must load the named mappings file. Often for an extract operation this file will not exist at this point, although it may be that the intent is to add to an existing file. The task of gathering the list of files to process (as indicated by the command line options) is common to both the extract and the localize actions, and is performed next, making use of some of the methods on the FileUtils helper class 20. Each file so located is then either passed to the ‘extract’ method or the ‘localize’ method, dependant of the action parsed from the command line. When acting for the extract action, the ‘go’ method must write out the properties file that was either created (or extended) before completing.

The extract action performed on a file begins by scanning for localize tags that already bear unique ids, adding these to a collection of the tags in the file. Then the system scans for tags that do not yet have ids, making use of the methods on the UniqueIdGenerator 30 to create a new id that is not already in use, and adds the new tag to the growing collection. The file content is amended to reflect the new id of the tag. When all files are processed, this collection will represent the required content of the properties file. When performing the localize option, the files are processed in a different manner. The system simply walks through the file comparing the ids of tags, and replacing the content of the tags with the value of the corresponding property from the loaded properties file. An additional task when localizing a file is to replace occurrences of the original locale with the new locale, each having been indicated on the command line.

It should be noted that the above-provided description the present invention is one of the many possible implementations of the tool whose functionality has been described here in detail.

What is claimed is:

1. A method of translating a web page, a method comprising:
scanning an original page to select locale-specific content in the original page;
enclosing the locale-specific content in predefined tags to create tagged text;
extracting the tagged text from the original page to create a file mapping a set of identifiers and the locale-specific content; and
translating the web page by replacing the tagged text in the original page by the content to be displayed in a translated web page.

2. The method of claim 1, wherein the locale-specific content is textual information.

3. The method of claim 2, wherein the locale-specific content comprises textual information in English.

4. The method of claim 1, wherein the original page can be an HTML or JSP page or JavaScript file.

5. The method of claim 1, wherein the tagged text is enclosed in the <localize> tags.

6. The method of claim 5, wherein the tagged text comprises HTML tags or JSP tags or JavaScript.

7. Method of providing a locale-specific web page the method comprising;
selecting locale-specific content in an original page;
tagging the locale-specific content in the original page by predefined tags to create tagged text;
extracting the tagged text from the original page to create a mapping file mapping a set of identifiers and the locale-specific contents;
translating the tagged text in the locale-specific page by replacing the tagged text in accordance with the mapping file entries; and
displaying the translated locale-specific web page to a user.

8. The method of claim 7, wherein the locale-specific content is textual information.

9. The method of claim 8, wherein the locale-specific content comprises textual information in English.

10. The method of claim 7, wherein the original page can be an HTML or JSP page or JavaScript file.

11. The method of claim 7, wherein the tagged text is enclosed in the <localize> tags.

12. The method of claim 11, wherein the tagged text comprises HTML tags or JSP tags or JavaScript.
